(19) United States
(12) Patent Application Publication
(10) Pub. No.: US 2003/0231501 A1
(43) Pub. Date: Dec. 18, 2003

(54) Decorative lamp assembly for representing characters

(76) Inventor: Han-Ming Lee, Taipei City (TW)

Correspondence Address: Han-Ming Lee, P.O. BOX 7-820, Taipei City, TW

(21) Appl. No.: 10/171,557

(22) Filed: Jun. 14, 2002

(51) Int. Cl. F21S 2/00

(52) U.S. Cl. 362/382

(57) ABSTRACT

A decorative lamp assembly including a plurality of lamp unit each comprises a socket including a plurality of spaced top and bottom latched pieces, a plurality of equally spaced vertical ridge sections each consisting of a ridge and two side troughs, and a plurality of equally spaced vertical groove sections each consisting of a groove and two side ribs wherein the ridge and the groove sections are alternate. A bulb is secured by the latched pieces to form a lamp unit. A plurality of lamp units are assembled together by securing the ridge sections of one lamp unit to the groove sections of adjacent lamp units with the ridges of one lamp unit fastened in the grooves of the adjacent lamp units and the ribs of one lamp unit fastened in the side troughs of the adjacent lamp units respectively for showing character(s) when the lamp units are turned on.

### BACKGROUND OF THE INVENTION

1. Field of the Invention

The present invention relates to decorative lamps and more particularly to an improved decorative lamp assembly for representing characters.

2. Description of the Prior Art

Decorative lamps are well known. Conventionally, such decorative lamps are arranged as a string being hung on tree(s) or the like. However, as observed by the inventor there is no document about permitting a user to arrange the decorative lamps as a board for representing one or more characters. Hence, a need exists for such improvement.

### SUMMARY OF THE INVENTION

It is therefore an object of the present invention to provide a decorative lamp assembly including a plurality of lamp unit each comprising a socket including a plurality of equally spaced top latched pieces, a plurality of equally spaced bottom latched pieces, a plurality of equally spaced vertical ridge sections each consisting of a ridge and two side troughs, and a plurality of equally spaced vertical groove sections each consisting of a groove and two side ribs wherein the ridge and the groove sections are alternate; and a cylindrical bulb having a lower enlargement. In assembly, the bulb is inserted through the socket from bottom to top until the enlargement of the bulb is secured between the top and the bottom latched pieces to form a lamp unit so that it is possible of assembling a plurality of lamp units together by securing the ridge sections of one lamp unit to the groove sections of two, three, or four adjacent lamp units with the ridges of one lamp unit fastened in the grooves of the adjacent lamp units and the ribs of one lamp unit fastened in the side troughs of the adjacent lamp units respectively for showing one or more characters when the plurality of lamp units are turned on.

The above and other objects, features and advantages of the present invention will become apparent from the following detailed description taken with the accompanying drawings.

### BRIEF DESCRIPTION OF THE DRAWINGS

FIG. 1 is a perspective view of a string of preferred embodiment of a lamp of decorative lamp assembly according to the invention;

FIG. 2 is an exploded perspective view of the FIG. 1 lamp;

FIG. 3 is a perspective view of the assembled lamp;

FIG. 4 is a broken-away perspective view of the lamp; and

FIG. 5 is a perspective view showing a word “LOVE” arranged by a plurality of lamps of decorative lamp assembly.

### DELTAILED DESCRIPTION OF THE PREFERRED EMBODIMENT

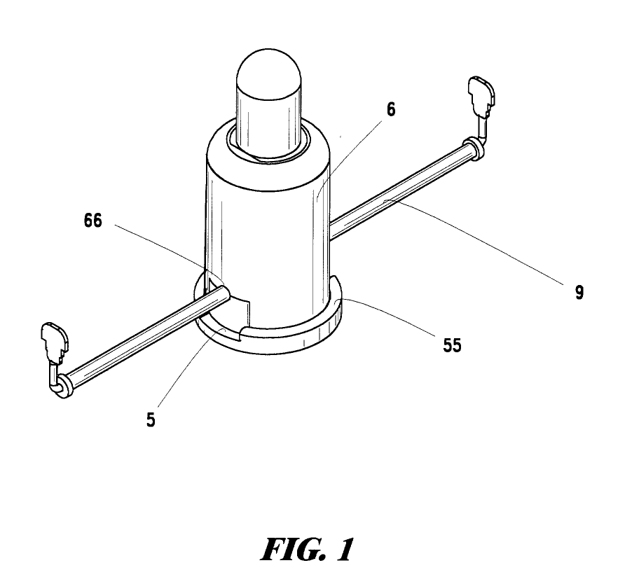

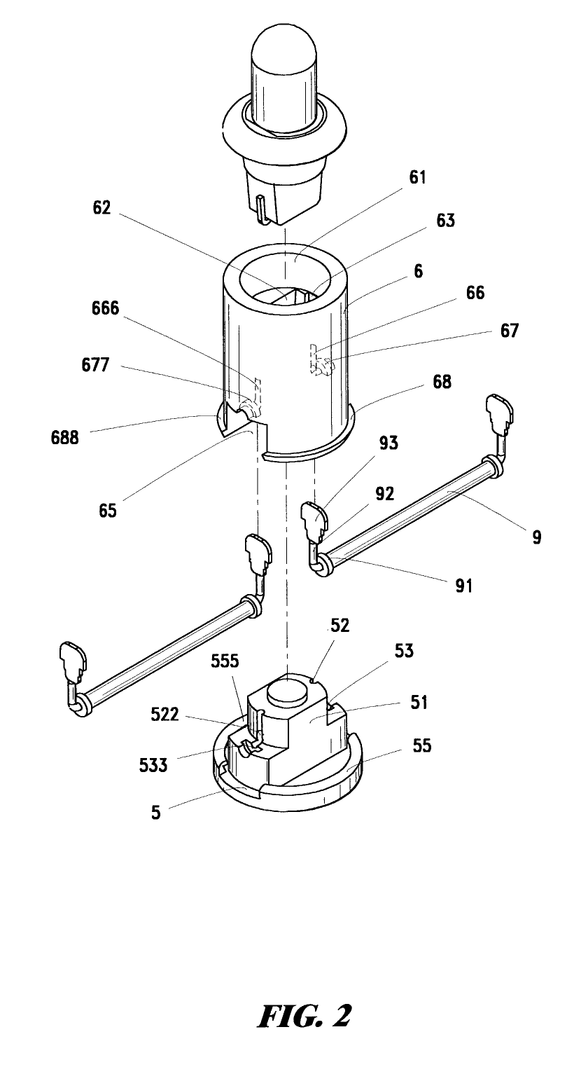

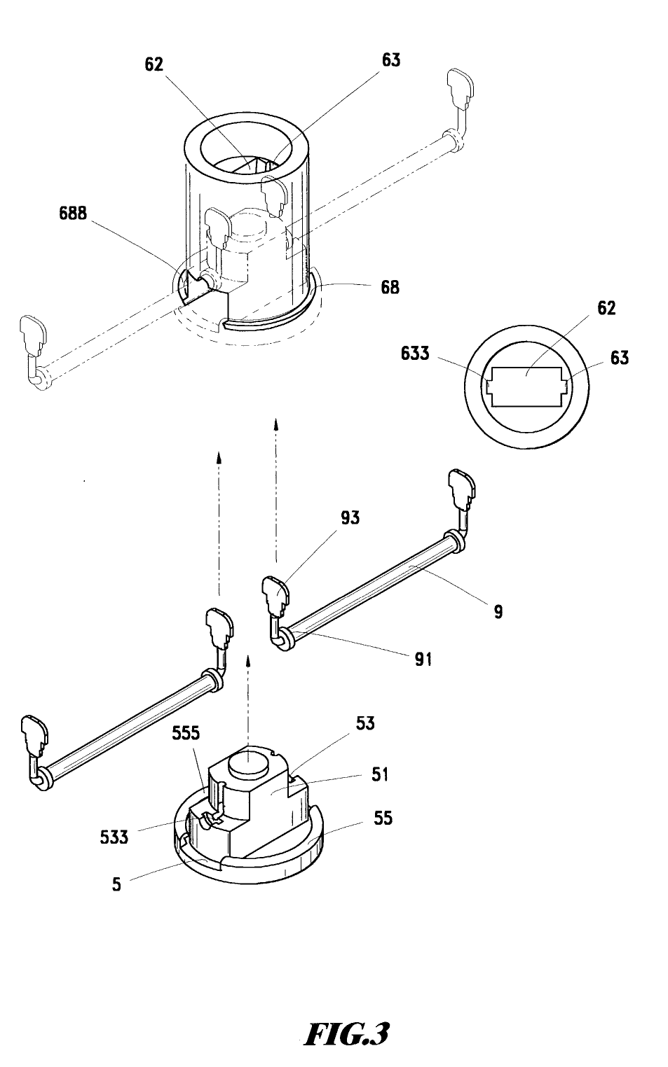

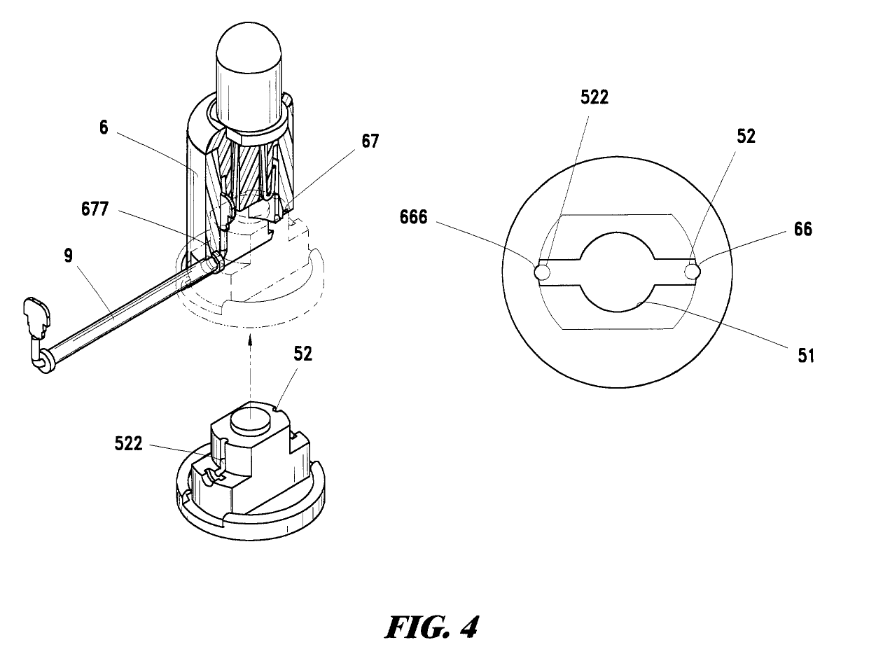

With reference to the drawings and in particular to FIGS. 1 to 4, there is shown a lamp constructed in accordance with the invention comprising a socket 1 and a bulb 8 such as LED (Light Emitting Diode) of bullet shape and having a lower enlargement.

The socket 1 comprises a plurality of equally spaced top latched pieces 53, 151 and 152, a plurality of equally spaced bottom latched pieces 16, 161 and 162, a plurality of equally spaced vertical ridge sections each consisting of a ridge 11 and two side troughs 121 and 122, and a plurality of equally spaced vertical groove sections each consisting of a groove 13 and two side ribs 131 and 132 wherein the ridge and the groove sections are alternate.

In assembly, insert the bulb 8 through the socket 1 from bottom to top until the enlargement of the bulb 8 is secured between the top and the bottom latched pieces 53, 151, 152, 16, 161, and 162. This completes a lamp unit.

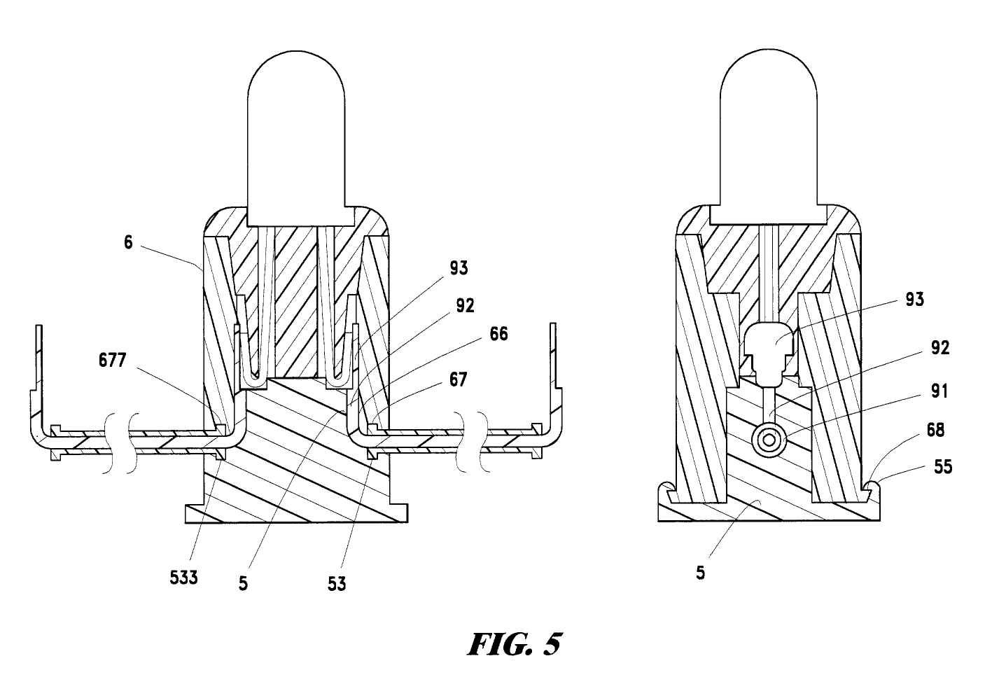

Referring to FIG. 5, further, a plurality of lamp units may be assembled together by securing the ridge sections of one lamp unit to the groove sections of two, three, or four adjacent lamp units (i.e., the ridges 11 fastened in the grooves 13 and the ribs 131 and 132 fastened in the side troughs 121 and 122 respectively). This forms a decorative lamp assembly. As shown, a word “LOVE” is arranged by the plurality of lamp units.

While the invention has been described by means of specific embodiments, numerous modifications and variations could be made thereto by those skilled in the art without departing from the scope and spirit of the invention set forth in the claims.

What is claimed is:

1. A decorative lamp assembly including a plurality of lamp unit each comprising:
a socket including a plurality of equally spaced top latched pieces, a plurality of equally spaced bottom latched pieces, a plurality of equally spaced vertical ridge sections each consisting of a ridge and two side troughs, and a plurality of equally spaced vertical groove sections each consisting of a groove and two side ribs wherein the ridge and the groove sections are alternate; and
a cylindrical bulb having a lower enlargement;
Wherein in assembly, the bulb is inserted through the socket from bottom to top until the enlargement of the bulb is secured between the top and the bottom latched pieces to form a lamp unit so that it is possible of assembling a plurality of lamp units together by securing the ridge sections of one lamp unit to the groove sections of two, three, or four adjacent lamp units with the ridges of one lamp unit fastened in the grooves of the adjacent lamp units and the ribs of one lamp unit fastened in the side troughs of the adjacent lamp units respectively for showing one or more characters when the plurality of lamp units are turned on.
